(19) United States
(12) Patent Application Publication
(10) Pub. No.: US 2005/0041336 A1
(43) Pub. Date: Feb. 24, 2005

(54) Magnetic head assembly having trimming recesses, method for producing the same, and magnetic-tape recording and playback apparatus

(75) Inventor: Katsuya Kikuiri, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 10/911,814

(22) Filed: Aug. 5, 2004

(30) Foreign Application Priority Data
Aug. 19, 2003 (JP) 2003-295317

(51) Int. Cl. G11B 5/147

(52) U.S. Cl. 360/126

(57) ABSTRACT

A multichannel magnetic head assembly includes a head container having thin-film magnetic heads therein. Each of the thin-film magnetic heads includes a gap layer and a pair of core layers, and leading end portions of the gap layer and the core layers are exposed from a medium-sliding surface. The thin-film magnetic heads are disposed inside the head container so that the widths thereof in the track-width direction are inclined at the same azimuth angle. A pair of trimming recesses provided on the medium-sliding surface include edge lines extending on both sides in the track-width direction of the gap layer and the core layers and in the traveling direction of the thin-film magnetic head. The magnetic head assembly maintains a high S/N ratio of reproduction signals, and reduces errors in the relative positions among the thin-film magnetic heads.

### BACKGROUND OF THE INVENTION

1. Field of the Invention

The present invention relates to a magnetic head assembly, a method for producing the same, and a magnetic-tape recording and playback apparatus. More particularly, the present invention relates to a multichannel magnetic head assembly for use in helical scanning, and a production method therefor.

2. Description of the Related Art

Helical-scan magnetic recording has been widely used; in this method, information is recorded on a magnetic tape that is placed diagonally around the peripheral surface of a rotating drum having a magnetic head while the rotating drum is being rotated at high speed. As shown in FIG. 25, in this scanning method, recording tracks 105 are provided at a predetermined angle to the running direction L (longitudinal direction) of a magnetic tape 101.

In helical-scan magnetic recording, a so-called guard bandless recording method is generally used. In this method, there is no band between adjoining recording tracks 105 in order to achieve high-density recording of magnetic information on the magnetic tape 101, as shown in FIG. 25. The azimuth angles of the adjoining recording tracks 105 are made different in order to prevent signals from mixing between the recording tracks 105 during reproduction of magnetic information (crosstalk).

In recent years, it has been suggested that a narrow-track thin-film magnetic head produced by a thin-film process should be used to read and write information from and on a magnetic tape in order to increase the recording density, as disclosed in, for example, Japanese Unexamined Patent Application Publication No. 2001-52304. Furthermore, an inductive head having a lower core layer that is partly raised to prevent magnetic fringing is known as a magnetic head for hard disks, as disclosed in, for example, Japanese Unexamined Patent Application Publication No. 11-328616. In addition, a multichannel magnetic head unit has recently been developed which performs magnetic recording and reproduction by the helical scanning method while simultaneously forming a plurality of recording tracks with a magnetic head including a plurality of thin-film magnetic heads having the same azimuth angle, and another magnetic head that is different only in the azimuth angle.

In the above-described guard bandless recording method, an overlapping recording region is generally formed on the boundary between the adjoining recording tracks. When a first recording track 106 and a subsequent second recording track 107 are formed with magnetic heads 102a and 102b each composed of a pair of core layers 111 and 112 having substantially rectangular leading ends in plan view, as shown in FIG. 26, an end of the magnetic head 102b reaches the recording track 106 across the overlapping recording region 110, and a leakage field between the leading ends of the core layers 111 and 112 may adversely affect the first recording track 106. As a result, the effective track width of the first recording track 106 is reduced, and the S/N ratio of reproduction signals is decreased.

In one production method for a multichannel magnetic head, a plurality of thin-film magnetic heads are stacked on a nonmagnetic substrate by a thin-film process, the nonmagnetic substrate is cut into split blocks, and each of the split blocks is combined with a block-shaped holding member. In this method, when a plurality of thin-film magnetic heads are stacked, a planarizing process must be performed to planarize the surfaces of the thin-film magnetic heads. Since the accuracy of the planarizing process is relatively low, the relative positions among the thin-film magnetic heads change. The change is particularly large when the azimuth angle is large.

### SUMMARY OF THE INVENTION

In view of the above-described circumstances, an object of the present invention is to provide a multichannel magnetic head assembly that maintains a high S/N ratio of reproduction signals and that reduces errors in the relative positions among thin-film magnetic heads, a production method therefor, and a magnetic-tape recording and playback apparatus.

In order to achieve the above object, according to one aspect, the present invention provides a magnetic head assembly including a head container. The head container includes a medium-sliding surface; a plurality of thin-film magnetic heads provided inside the head container so that the widths thereof in the track-width direction are inclined at the same azimuth angle, each of the thin-film magnetic heads including a gap layer and a pair of core layers sandwiching the gap layer, and leading end portions of the gap layer and the core layers being exposed from the medium-sliding surface; and a pair of trimming recesses provided on the medium-sliding surface. The trimming recesses include edge lines extending on both sides in the track-width direction of the gap layer and the core layers and in the traveling direction of the thin-film magnetic head.

In the above magnetic head assembly, a plurality of thin-film magnetic heads are provided inside the head container, and the widths thereof in the track-width direction are inclined at the same azimuth angle. Therefore, the magnetic head assembly is used as a multichannel magnetic head. Since a pair of trimming recesses are provided on the medium-sliding surface to include edge lines extending in the traveling direction of the thin-film magnetic heads on both sides in the track-width direction of the gap layer and the core layers, the portions of the gap layer and the core layers exposed from the medium-sliding surface are substantially parallelogrammatic in plan view, and the extending direction of the edge lines is the same as the sliding direction of the thin-film magnetic head on the magnetic tape.

Consequently, when magnetic recording on a magnetic tape is performed with this magnetic head assembly by helical scanning, the end portions of the core layers of the thin-film magnetic heads will not protrude outward from an overlapping recording region. Since a leakage field produced between the end portions of the core layers does not adversely affect the adjoining recording track, the effective track width of the recording track is not reduced, and the S/N ratio of reproduction signals is increased.

Preferably, the trimming recesses are filled with a nonmagnetic material. Filling of the nonmagnetic material makes the medium-sliding surface even and smooth. Consequently, the magnetic tape can smoothly slide on the medium-sliding surface. Moreover, since a leakage field from the end portions of the core layers of the thin-film magnetic heads is reduced, the effective track width of the recording track is not reduced, and the S/N ratio of reproduction signals is increased.

Preferably, the edge lines of the thin-film magnetic heads are parallel to one another. In this case, overlapping recording regions between the recording tracks on the magnetic tape can be made small, and the magnetic recording density is increased.

Preferably, each of the core layers includes the leading end portion exposed from the medium-sliding surface, and a main core portion disposed at a distance from the medium-siding surface, and the width of the leading end portion in the track-width direction is smaller than the width of the main core portion. In this case, the strength of a recording magnetic field applied from the leading end portion of the core layer to the magnetic tape is increased, and the S/N ratio is increased further.

According to another aspect, the present invention provides a magnetic-tape recording and playback apparatus including a rotating drum having the above magnetic head assembly. A tape-loading path is defined by winding a magnetic tape drawn from a tape reel on the rotating drum.

Since the magnetic-tape recording and playback apparatus includes the above magnetic head assembly, the leading end portions of the core layers of the thin-film magnetic heads will not protrude outward from overlapping recording regions. Since a leakage field produced between the leading end portions of the core layers does not adversely affect the adjoining track, the effective track width of the recording track is not reduced, and the S/N ratio of reproduction signals is increased.

Preferably, the tape-loading path includes the rotating drum, guide posts disposed on the upstream and downstream sides of the rotating drum to guide the magnetic tape drawn from the tape reel onto the rotating drum, and a capstan disposed on the downstream side of the rotating drum to feed the magnetic tape.

According to a further aspect, the present invention provides a method for producing a magnetic head assembly. The method includes a thin-film magnetic-head forming step of forming a plurality of thin-film magnetic heads on a nonmagnetic substrate, each of the thin-film magnetic heads including a gap layer and a pair of core layers sandwiching the gap layer; a cutting step of forming split bars by cutting the nonmagnetic substrate, each of the split bars including some of the thin-film magnetic heads, and leading end portions of the gap layer and the core layers in each of the thin-film magnetic heads being exposed from a cutting surface; and a trimming step of forming a resist film on the cutting surface of the split bar, forming a plurality of patterning holes in the resist film, and etching the cutting surface through the patterning holes of the resist film to form a pair of trimming recesses including edge lines extending on both sides in the track-width direction of the gap layer and the core layers in the thin-film magnetic head and in the traveling direction of the thin-film magnetic head.

Since the leading end portions of the gap layer and the core layers in each split bar are trimmed by photolithography, trimming can be performed efficiently.

Even when the relative positions of the thin-film magnetic heads are changed by a process error during the thin-film magnetic-head forming step, since the core layers and the gap layer are trimmed to adjust the track width after the thin-film magnetic heads are formed, the error can be removed, and the formation of the edge lines on both sides in the track-width direction of the gap layer and the core layers and the adjustment of the track width can be performed precisely. Moreover, the inclination angle of the edge lines can be fixed, and the azimuth angles of the thin-film magnetic heads can be made the same.

Preferably, the method further includes a step of filling the trimming recesses with a nonmagnetic material after the trimming step. Since the nonmagnetic material is filled on both sides in the track-width direction of the thin-film magnetic heads, a leakage field can be reduced, and the medium-sliding surface can be made even and smooth.

Preferably, wherein, in the thin-film magnetic-head forming step, the thin-film magnetic heads comprise first thin-film magnetic heads and second thin-film magnetic heads, the first thin-film magnetic heads are formed at regular intervals on the nonmagnetic substrate, and are covered with an overcoat layer, and the second thin-film magnetic heads are formed at regular intervals on the overcoat layer so as to be offset in the track-width direction from the first thin-film magnetic heads.

In this case, the gap layers of the thin-film magnetic heads can be disposed parallel to each other, and the azimuth angles can be made the same.

Preferably, in the thin-film magnetic-head forming step, the width of the thin-film magnetic heads in the track-width direction is set to be larger than a track width required after the trimming step. Since the width of the thin-film magnetic heads in the track-width direction can be adjusted in the trimming step, the thin-film magnetic heads can have the same width.

As described above, since the leading end portions of the core layers and the gap layer in each split bar are trimmed, trimming can be performed efficiently. Moreover, since trimming is performed to adjust the track width after the thin-film magnetic heads are formed, a process error during the thin-film magnetic-head forming step can be removed, and the formation of the edge lines on both sides in the track-width direction of the gap layer and the core layers and the adjustment of the track width can be performed precisely.

Further objects, features, and advantages of the present invention will become apparent from the following description of the preferred embodiments with reference to the attached drawings.

### BRIEF DESCRIPTION OF THE DRAWINGS

FIG. 1 is a plan view schematically showing a tape-loading path provided in a magnetic-tape recording and playback apparatus according to an embodiment of the present invention;

FIG. 2 is an enlarged perspective view of a rotating drum shown in FIG. 1;

FIG. 3A is a perspective view showing the structure of a magnetic head assembly according to the present invention, and FIG. 3B is a plan view of the magnetic head assembly, as viewed from the side of a medium-sliding surface;

FIG. 4 is a schematic sectional view showing a thin-film magnetic head provided in the magnetic head assembly of the present invention, taken along line IV-IV in FIG. 3B;

FIG. 5 is a schematic plan view of a head container in the principal part of the magnetic head assembly, as viewed from the side of the medium-sliding surface;

FIG. 6 is a schematic perspective view showing a leading end portion of the thin-film magnetic head and trimming recesses in the principal part of the magnetic head assembly;

FIG. 7 is a schematic view showing the relationship between the traveling direction of thin-film magnetic heads and recording tracks provided on a magnetic tape;

FIG. 8 is a schematic view showing the relationship between the moving direction of thin-film magnetic heads and recording tracks provided on the magnetic tape;

FIG. 9 is a process view showing a thin-film magnetic-head forming process in a production method for a magnetic head assembly according to the present invention;

FIG. 10 is a cross-sectional view, taken along line X-X in FIG. 9;

FIG. 11 is a cross-sectional view, taken along line X-X in FIG. 9;

FIG. 12 is a process view showing the thin-film magnetic-head forming process in the production method;

FIG. 13 is a cross-sectional view, taken along line XIII-XIII in FIG. 12;

FIG. 14 is a process view showing a cutting process in the production method of the present invention;

FIG. 15 is a perspective view of a split bar obtained in the cutting process;

FIG. 16 is a transparent plan view of thin-film magnetic heads, as viewed from the side of an overcoat layer of the split bar in a trimming process of the production method of the present invention;

FIG. 17 is a schematic front view of the split bar shown in FIG. 16, as viewed from the cutting surface;

FIG. 18 is an enlarged schematic view showing the principal part of the split bar shown in FIG. 16.

FIG. 19 is an enlarged schematic view showing the principal part of the split bar shown in FIG. 17;

FIG. 20 is an enlarged transparent plan view of the thin-film magnetic heads, as viewed from the side of the overcoat layer of the split bar in the trimming process;

FIG. 21 is an enlarged transparent plan view of the thin-film magnetic heads, as viewed from the side of the overcoat layer of the split bar in the trimming process;

FIG. 22 is a perspective view showing cutting positions of the split bar;

FIG. 23 is a perspective view of a head container obtained by the production method;

FIG. 24 is a perspective view of a magnetic head assembly obtained by the production method;

FIG. 25 is a schematic explanatory view showing magnetic recording on a magnetic recording medium; and

FIG. 26 is a schematic explanatory view showing magnetic recording with known magnetic heads.

### DESCRIPTION OF THE PREFERRED EMBODIMENTS

First Embodiment

A first embodiment of the present invention will be described below with reference to the attached drawings.

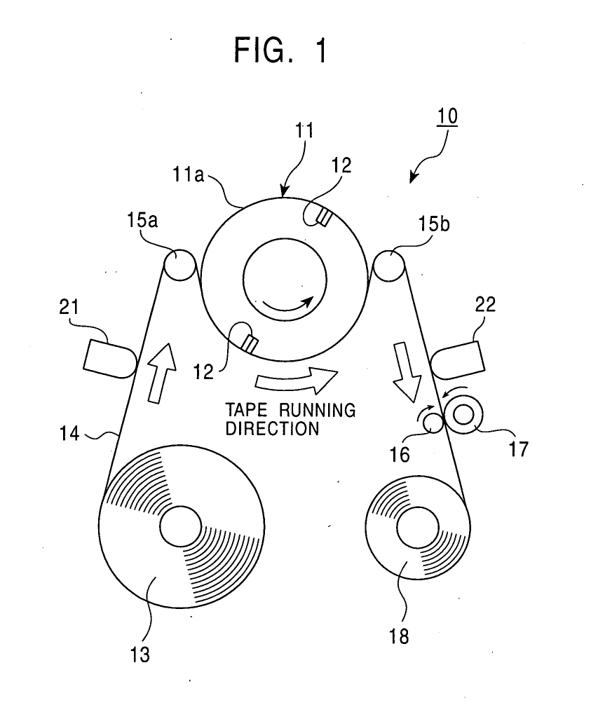

FIG. 1 is a schematic plan view of a tape-loading path in a magnetic-tape recording and playback apparatus according to the first embodiment. A magnetic-tape recording and playback apparatus 10 shown in FIG. 1 is used in, for example, a video tape recorder. In the magnetic-tape recording and playback apparatus 10, magnetic head assemblies 12 (12a and 12b) according to the present invention are mounted on a rotating drum 11 that is rotated by a motor. A magnetic tape 14 drawn from a supply tape reel 13 is guided by a guide post 15a, is wound on the rotating drum 11 through a predetermined angle. The magnetic tape 14 is then guided by a guide post 15b, is nipped between a capstan 16 and a pinch roller 17, and is fed in the direction shown by the arrows by the rotation of the capstan 16. Finally, the magnetic tape 14 is wound around a take-up tape reel 18. In this way, the rotating drum 11 having the magnetic head assemblies 12 and the magnetic tape 14 define a tape-loading path. In the tape-loading path, a full-width erase head 21 and an audio head 22 are also provided.

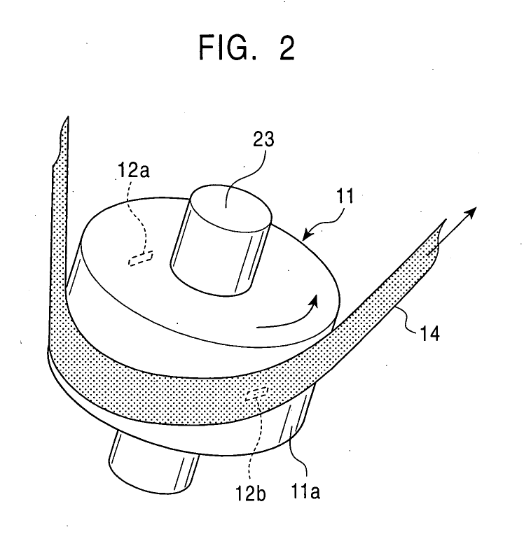

As shown in FIG. 2, the rotating drum 11 rotates about a rotating shaft 23 that is driven by a motor. The magnetic tape 14 runs while being diagonally pressed against a peripheral surface 11a of the rotating drum 11. Medium-sliding surfaces of the two magnetic head assemblies 12a and 12b are spaced, for example, 180°, and are exposed from the peripheral surface 11a of the rotating drum 11 so as to alternately touch the magnetic tape 14. The magnetic head assemblies 12a and 12b are disposed to record information on the magnetic tape 14 at different azimuth angles.

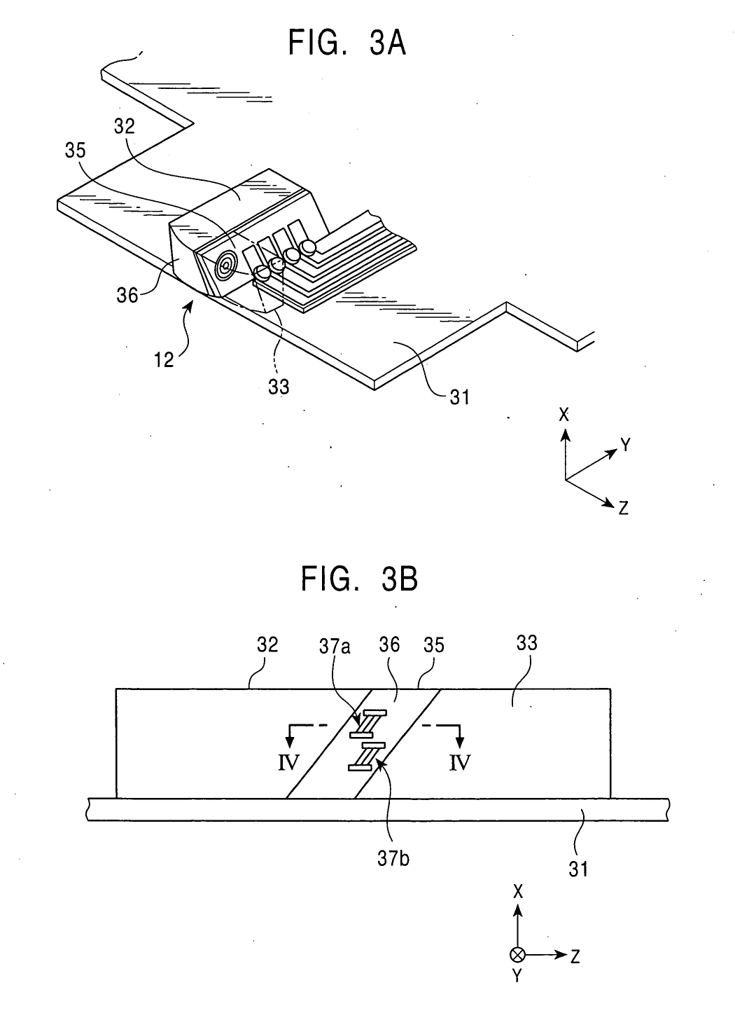

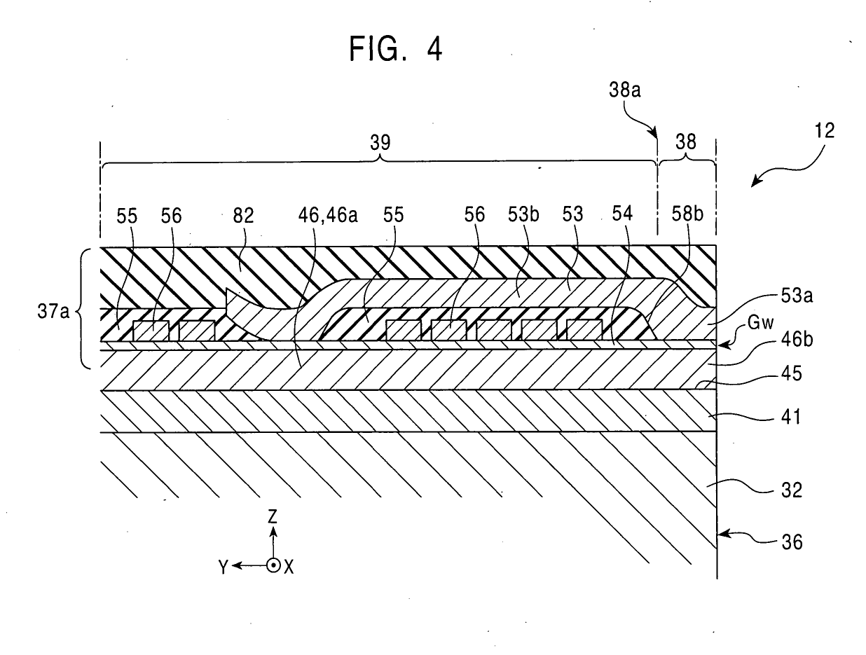

FIG. 3A is a schematic perspective view of each of the magnetic head assemblies 12 of the present invention, FIG. 3B is an enlarged plan view of the magnetic head assembly 12, as viewed from the side of the medium-sliding surface thereof, and FIG. 4 is a schematic sectional view, taken along line IV-IV in FIG. 3B. In these figures, the X-direction represents the direction of the normal to a base plate 31, the Y-direction represents the gap-depth direction of the magnetic head assembly 12, and the Z-direction represents the direction parallel to the base plate 31, that is, the traveling direction of the magnetic head assembly 12 (thin-film magnetic heads 37a and 37b). The X-, Y-, and Z-directions are orthogonal to one another.

The magnetic head assembly 12 includes a head container 35 in which a plurality of thin-film magnetic heads are provided, and first and second holding members 32 and 33 that sandwich the head container 35, as shown in FIGS. 3A and 3B. End faces of the first and second holding members 32 and 33 are combined by bonding with the head container 35 therebetween, thus forming a block as a whole. The block is fixed on the base plate 31 by bonding so that one side thereof slightly protrudes outward from an edge of the base plate 31. A sliding surface of the protruding portion of the magnetic head assembly 12 is worked in the shape of a convex surface to form a medium-sliding surface 36 that faces the magnetic tape 14.

As shown in FIGS. 3B and 4, the head container 35 includes thin-film magnetic heads 37a and 37b that define the principal part of the magnetic head assembly 12. As shown in FIG. 3B, the thin-film magnetic heads 37a and 37b are spaced from each other in the direction (X-direction) of the normal to the base plate 31 and in the direction (Z-direction) parallel to the base plate 31. That is, the thin-film magnetic head 37a is disposed on the upper left side of the thin-film magnetic head 37b.

FIG. 4 is a schematic sectional view of the thin-film magnetic head 37a. Since the cross-sectional structure of the thin-film magnetic head 37b is the same as that of the thin-film magnetic head 37a shown in FIG. 4, a description thereof with reference to the figure is omitted. As shown in FIG. 4, the thin-film magnetic head 37a is provided on a nonmagnetic substrate 41, and is mainly composed of a magnetic-pole end section 38 including the medium-sliding surface 36, and a magnetic-pole base section 39 that adjoins the magnetic-pole end section 38 at a distance from the medium-sliding surface 36. Furthermore, the thin-film magnetic head 37a mainly includes a lower core layer 46, a gap layer 54 provided on the lower core layer 46 and made of a nonmagnetic material, and an upper core layer 53 provided on the gap layer 54.

The lower core layer 46 includes a leading end portion 46b provided in the magnetic-pole end section 38 and exposed from the medium-sliding surface 36, and a main core portion 46a provided in the magnetic-pole base section 39 and adjoining the leading end portion 46b. The upper core layer 53 includes a leading end portion 53a provided in the magnetic-pole end section 38 and exposed from the medium-sliding surface 36, and a main core portion 53b provided in the magnetic-pole base section 39 and adjoining the leading end portion 53a.

In the magnetic-pole end section 38, the lower core layer 46, the gap layer 54, and the upper core layer 53 are exposed in a stacked manner from the medium-sliding surface 36. The leading end portion 53a of the upper core layer 53 opposes the leading end portion 46b of the lower core layer 46 with the gap layer 54 therebetween, thus forming a magnetic gap Gw.

In the magnetic-pole end section 39, the gap layer 54 is provided on the main core portion 46a of the lower core layer 36. A magnetic coil layer 56 patterned in a two-dimensionally spiral form is provided on the gap layer 54, and is covered with an insulating layer 55. The upper core layer 53 is provided on the insulating layer 55. The upper surface of the upper core layer 54 is covered with an overcoat layer 82.

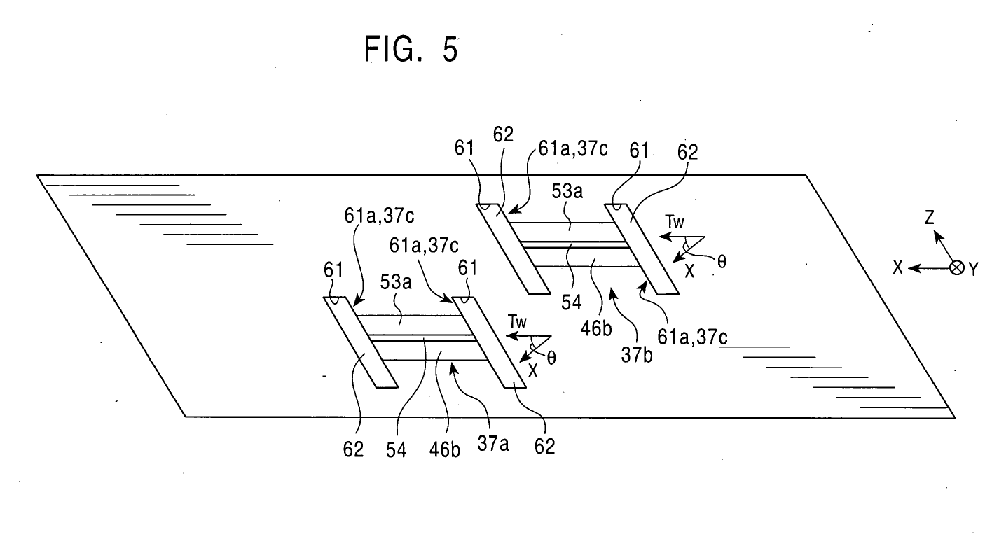

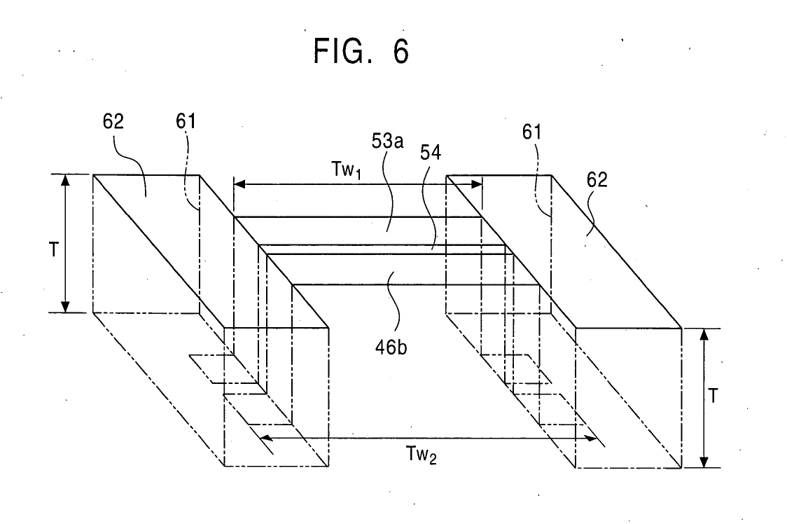

Detailed structures of the leading ends of the thin-film magnetic heads 37a and 37b will now be described with reference to FIGS. 5 and 6. As shown in FIG. 5, the track-width direction Tw of the gap layers 54 of the thin-film magnetic heads 37a and 37b are inclined at an angle θ to the normal direction (X-direction) of the base plate 31. Preferably, the angle θ is equal to or close to the azimuth angle set to perform azimuth recording on recording tracks of a magnetic tape, that is, within the range of 10° to 30°.

A pair of trimming recesses 61 are provided on both sides in the track width direction Tw of each of the thin-film magnetic heads 37a and 37b. Each of the trimming recesses 61 is filled with a nonmagnetic material 62 such as alumina. As shown in FIG. 5, the trimming recess 61 is substantially rectangular in plan view. Edge lines 61a adjoining the thin-film magnetic head 37a or 37b, of four edge lines that define the rectangular trimming recess 61, are inclined in the same direction as the traveling direction Z of the thin-film magnetic heads 37a and 37b. The edge lines 61a are parallel to each other, and are aligned with edge lines 37c that define both sides in the track-width direction Tw of the gap layer 54 and the core layers 46 and 53. That is, the edge lines 37c extend in the same direction as the traveling direction Z of the thin-film magnetic heads 37a and 37b.

As shown in FIG. 6, the depth T of the trimming recesses 61 is set to be within the range of 1 μm to 5 μm, from the viewpoint of the life time depending on abrasion, and is substantially equal to or larger than the length of the magnetic-pole end section 38 in the gap-depth direction shown in FIG. 4. Since the trimming recesses 61 are provided, the width Tw₁ of the leading end portions 46b and 53a of the core layers 46 and 53 in the track-width direction Tw is set to be smaller than the width Tw₂ of the main core portions 46a and 53b.

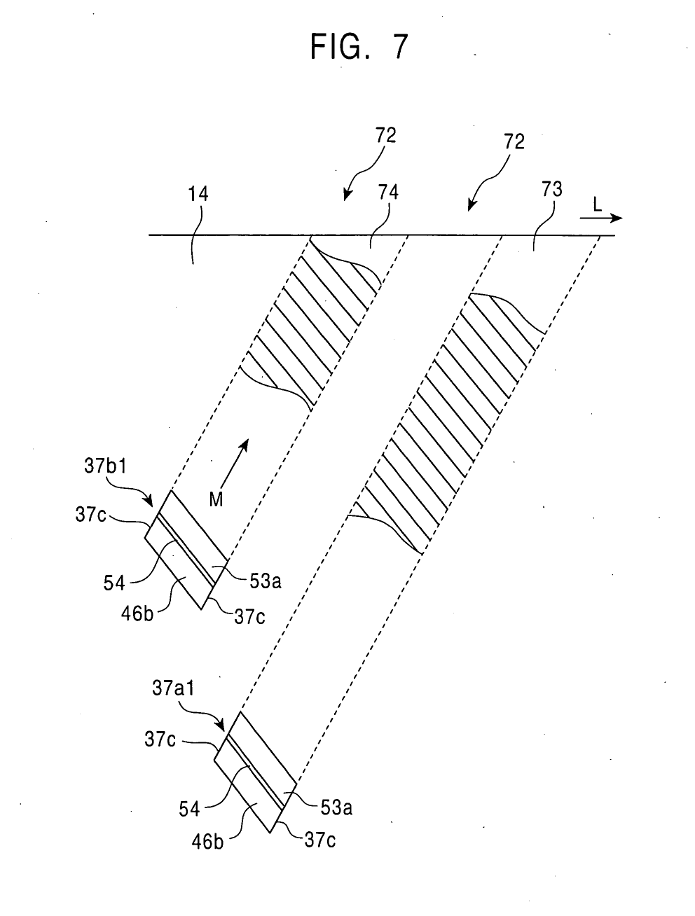

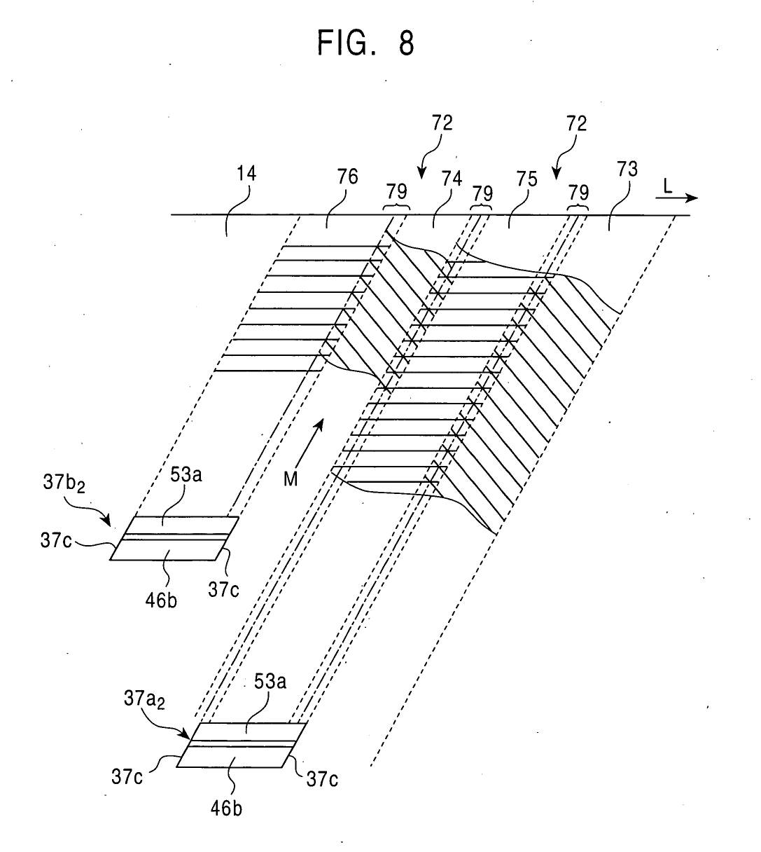

The operation of the magnetic head assembly 12 provided in the magnetic-tape recording and playback apparatus 10 having the above-described configuration will be described with reference to FIGS. 7 and 8. As shown in FIG. 7, a thin-film magnetic head 37a₁ and a thin-film magnetic head 37b₁ that constitute the magnetic head assembly 12a, of the two magnetic head assemblies 12 buried in the peripheral surface 11a of the rotating drum 11, record magnetic information, respectively, on a first recording track 73 and a second recording track 74 of a recording track 72.

As shown in FIG. 8, a thin-film magnetic head 37a₂ and a thin-film magnetic head 37b₂ that constitute the magnetic head assembly 12b record magnetic information, respectively, on a third recording track 75 and a fourth recording track 76 of the magnetic tape 14.

When the rotating drum 11 makes one turn, the first to fourth recording tracks 73 to 76 inclined at a given angle to the longitudinal direction L of the magnetic tape 14 are alternately formed on the magnetic tape 14, as shown in FIG. 8.

An overlapping recording region 79 in which an end of the succeeding third recording track 75 is superimposed on an end of the preceding first recording track 73 is provided in a contact portion between the first recording track 73 and the third recording track 75. This overlapping recording region 79 serves as a margin for deviation of the recording position due to, for example, an error in feeding the magnetic tape 14. Similarly, overlapping recording regions 79 are provided in the contact portions between the recording tracks 73 to 76.

When third and fourth recording tracks 75 and 76 are recorded subsequent to recording of the first and second recording tracks 73 and 74, since the edge lines 37c (61a) on both sides in the track-width direction of the thin-film magnetic heads 37a₂ and 37b₂ extend in the longitudinal direction M of the recording tracks 73 to 76, the leading end portions 46b and 53a of the core layers 46 and 53 of the thin-film magnetic heads 37a₂ and 37b₂ do not reach the first and second recording tracks 73 and 74 across the overlapping recording regions 79. Therefore, the effective track width of the first and second recording tracks 73 and 74 recorded earlier is not reduced, and a high SIN ratio of reproduction signals obtained by reading magnetic information from the magnetic tape 14 can be maintained.

Since the edge lines 37c (61a) are parallel to one another, the overlapping recording regions 79 between the recording tracks 73 to 76 on the magnetic tape 14 can be made small, and the magnetic recording density can be increased.

Since the cross-sectional shape of the leading end portions 46b and 53a of the core layers 46 and 53 are fixed from the medium-sliding surface 36 to the bottoms of the trimming recesses 61 having the depth T, as shown in FIG. 6, even when the medium-sliding surface 36 is slightly worn in the gap-depth direction Y, the effective track width of the first and second recording tracks 73 and 74 recorded earlier is not reduced.

Since the trimming recesses 61 are filled with the nonmagnetic material 62, the medium-sliding surface 36 is even, and therefore, allows the magnetic tape 14 to smoothly slide. Moreover, since a leakage field from the leading end portions 46b and 53a of the core layers 46 and 53 of the thin-film magnetic heads 37a and 37b is reduced, the effective track width of the recording tracks is prevented from reduction, and the S/N ratio of the reproduction signals can be increased.

Since the width Tw₁ in the track-width direction Tw of the leading end portions 46b and 53a is smaller than the width Tw₂ of the main core portions 46a and 53b, the strength of a recording magnetic field applied from the leading end portions 46b and 53a to the magnetic tape 14 can be increased, and the S/N ratio can be increased further.

Second Embodiment

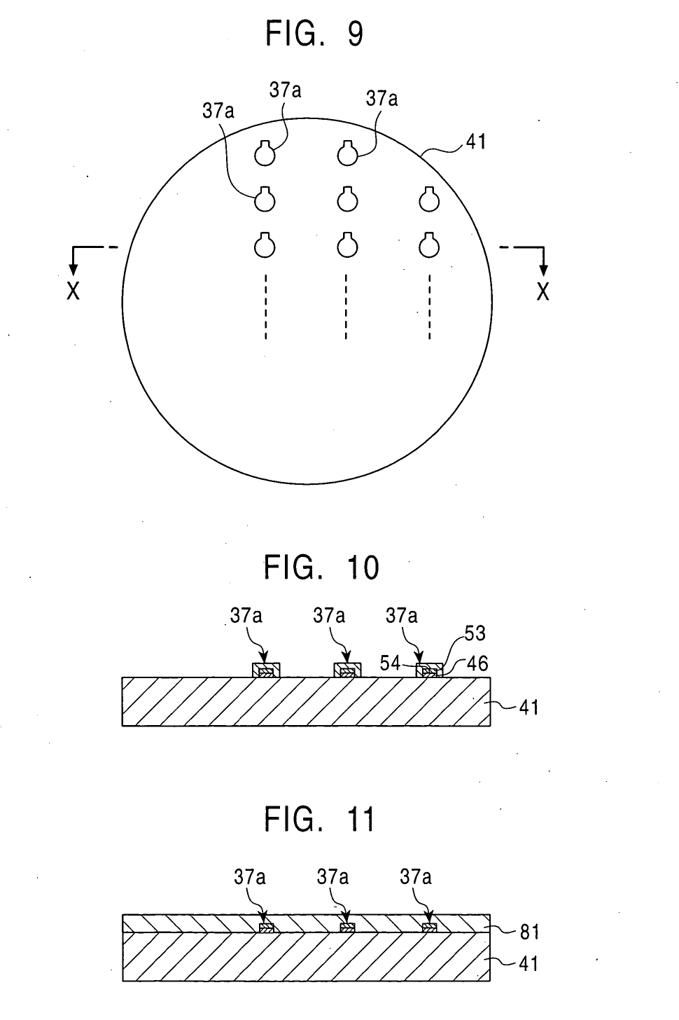

A production method for a magnetic head assembly 12 according to a second embodiment of the present invention will now be described with reference to FIGS. 9 to 24. The production method generally includes a thin-film magnetic-head forming process, a cutting process, and a trimming process.

In the first thin-film magnetic-head forming process, as shown in FIGS. 9 and 10, a plurality of thin-film magnetic heads 37a, each of which includes a gap layer 54 and a pair of core layers 46 and 53 sandwiching the gap layer 54, are formed at regular intervals on a nonmagnetic substrate 41. In this case, the track width of the core layers 46 and 53 and the gap layer 54 is set to be larger than the final track width. Subsequently, the nonmagnetic substrate 41 and the thin-film magnetic heads 37a are covered with an overcoat layer 81, as shown in FIG. 11. The upper surface of the overcoat layer 81 is planarized by, for example, CMP (chemical mechanical polishing).

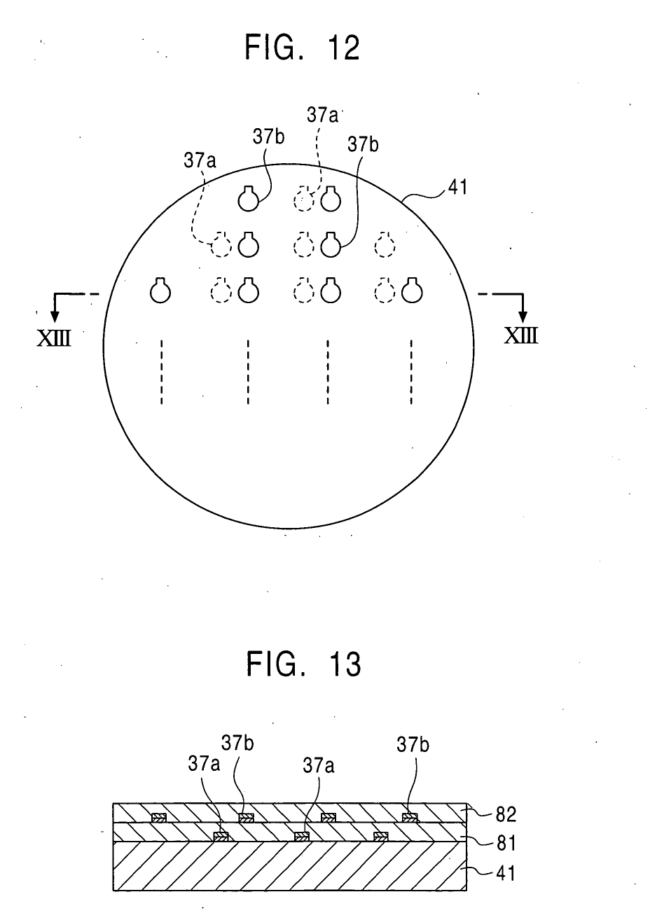

Then, as shown in FIGS. 12 and 13, thin-film magnetic heads 37b are formed at regular intervals on the overcoat layer 81, and are covered with another overcoat layer 82. The thin-film magnetic heads 37b are disposed offset from the thin-film magnetic heads 37a in the track-width direction. Preferably, in FIG. 12, the horizontal positions of leading end portions of the core layers of the thin-film magnetic heads 37a formed earlier are aligned with the horizontal positions of the leading end portions of the core layers of the thin-film magnetic heads 37b formed later. Since the upper surface of the overcoat layer 81 is planarized, the gap layers 54 of the thin-film magnetic heads 37a and 37b are parallel to each other.

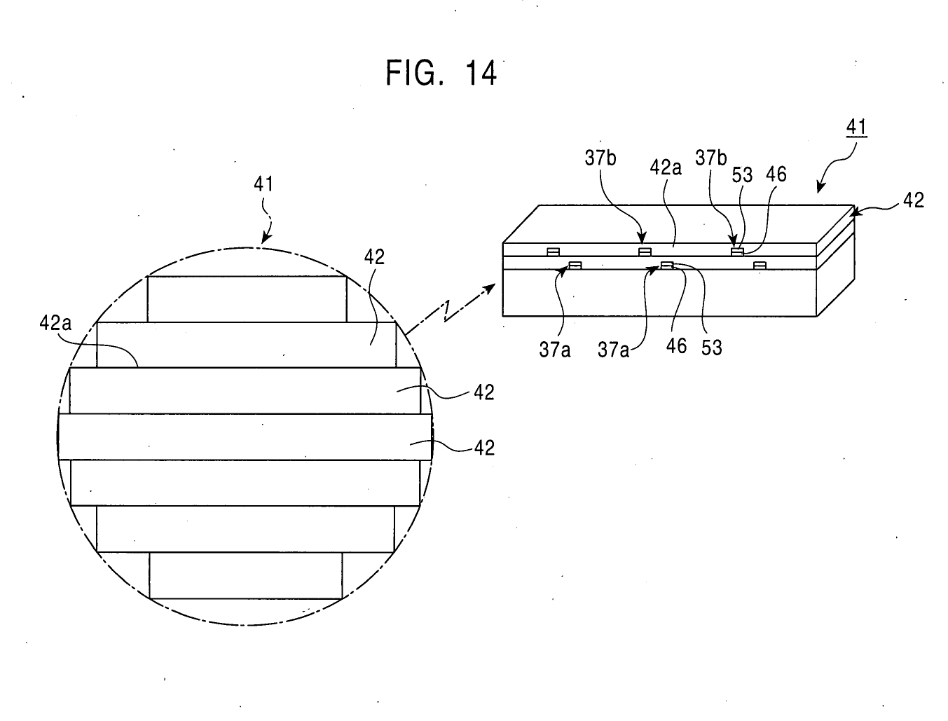

In the next cutting process, the nonmagnetic substrate 41 is cut into split bars 42. The nonmagnetic substrate 41 is cut so that leading end portions of the gap layer 54 and the core layers 46 and 53 are exposed from cutting faces 42a of the split bars 42. As a result of cutting, each split bar 42 includes a plurality of thin-film magnetic heads 37a and 37b, as shown in FIG. 14. The upper thin-film magnetic heads 37b and the lower thin-film magnetic heads 37a are arranged in the diagonal direction with respect to the thickness direction of the split bar 42, as shown in FIG. 15.

Subsequently, an auxiliary substrate 33 is bonded to a magnetic-head surface of the split bar 42. This allows the thin-film magnetic heads 37a and 37b to be disposed between the substrate 41 (first holding member 32) and the auxiliary substrate 33 (second holding member 33) after a final core-cutting operation.

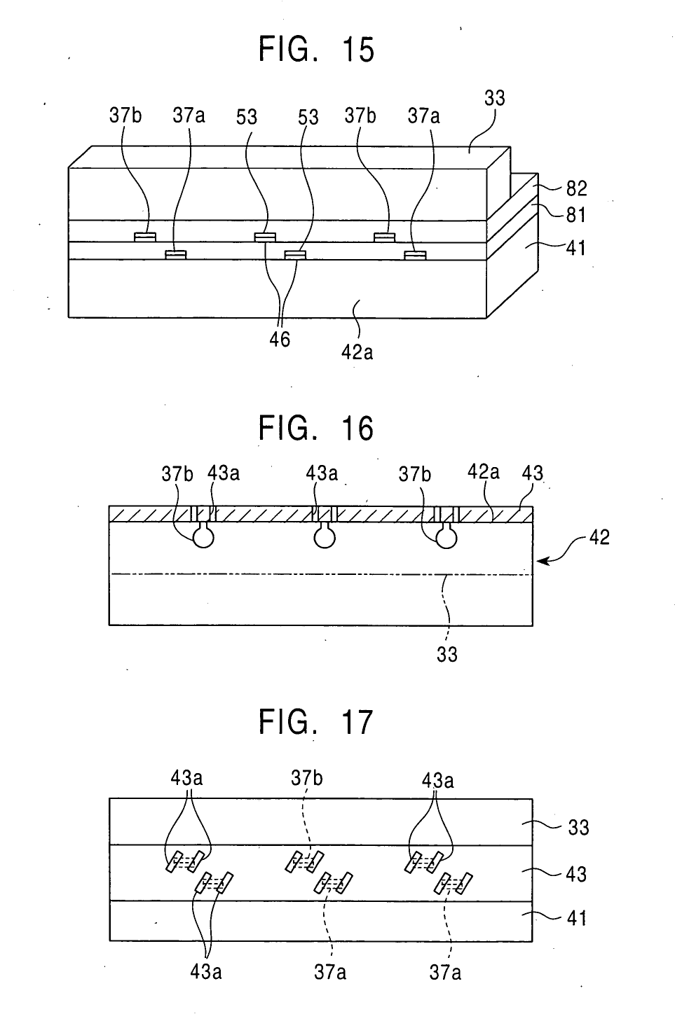

In the next trimming process, a resist film 43 is formed on the cutting surface 42a of the split bar 42, and is subjected to exposure and development with a masking layer placed thereon, so that a plurality of patterning holes 43a are formed, as shown in FIGS. 16 and 17.

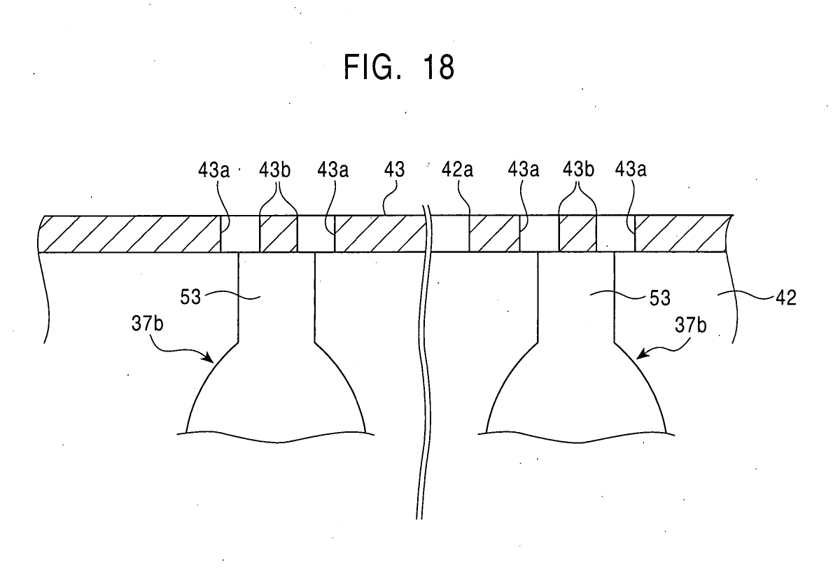

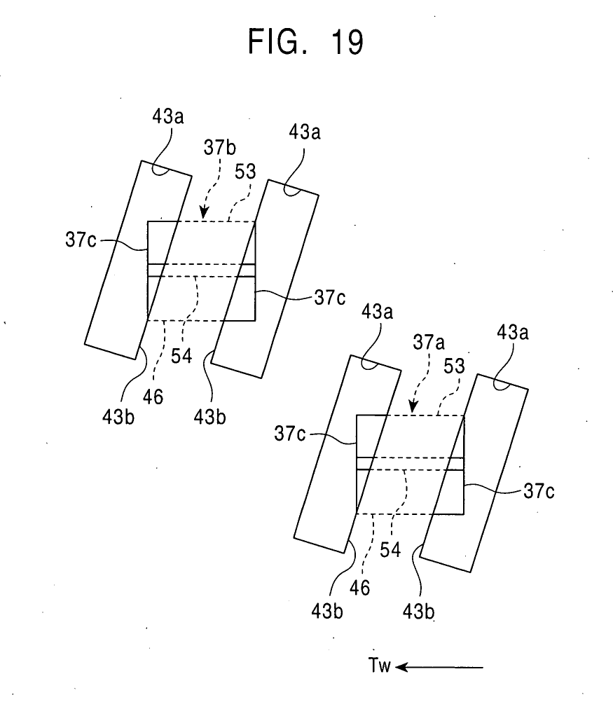

FIGS. 18 and 19 show the positional relationship between the patterning holes 43a and the thin-film magnetic heads 37a and 37b. The patterning holes 43a are substantially rectangular in plan view, and are provided on both sides in the track-width direction of the core layers 53 and 46 of the thin-film magnetic heads 37a and 37b. Edge lines 43b adjacent to the thin-film magnetic heads 37a and 37b, of the edge lines of the rectangular patterning holes 43a, are straight lines inclined at a given angle to the track-width direction Tw in plan view. The length of the edge lines 43b is larger than the thickness of the thin-film magnetic heads 37a and 37b. The distance between the edge lines 43b is smaller than the width of the gap layers 54 in the track-width direction Tw. In particular, all edge lines 37c that define the track widths of the core layers 46 and 53 and the gap layers 54 of the thin-film magnetic heads 37a and 37b are disposed inside the patterning holes 43a.

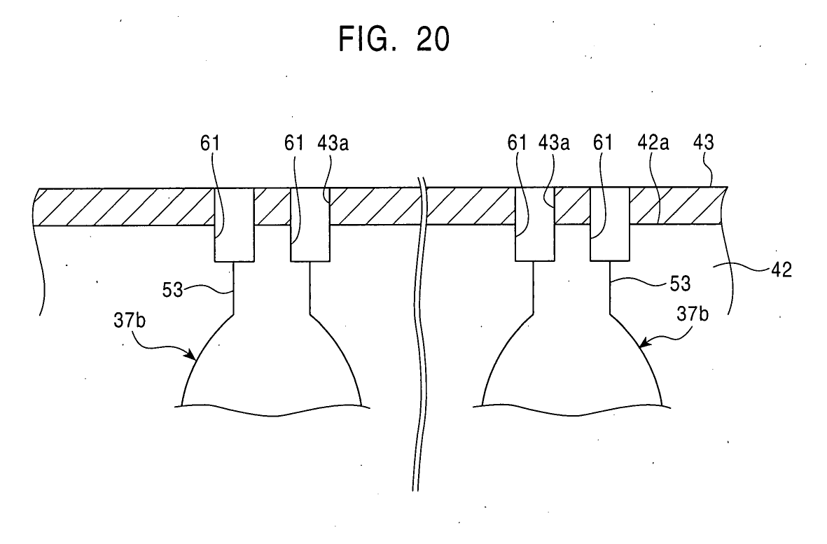

Next, the surface of the split bar 42 exposed from the patterning holes 43a is etched from above the resist film 43. Preferably, the surface is etched by anisotropic etching, such as ion milling. By etching the cutting surface 42a of the split bar 42, trimming recesses 61 are formed, as shown in FIG. 20. Preferably, etching is performed so that the depth of the trimming recesses 61 is larger than in final products, that is, is, for example, approximately 5 μm to 10 μm, in consideration of the cost of an operation of curving the medium-sliding surface that is performed later.

By forming the trimming recesses 61, both ends in the track-width direction of the leading end portions of the core layers 46 and 53 and the gap layer 54 are etched, and the width of the layers in the track-width direction are made smaller than when the thin-film magnetic heads are first formed.

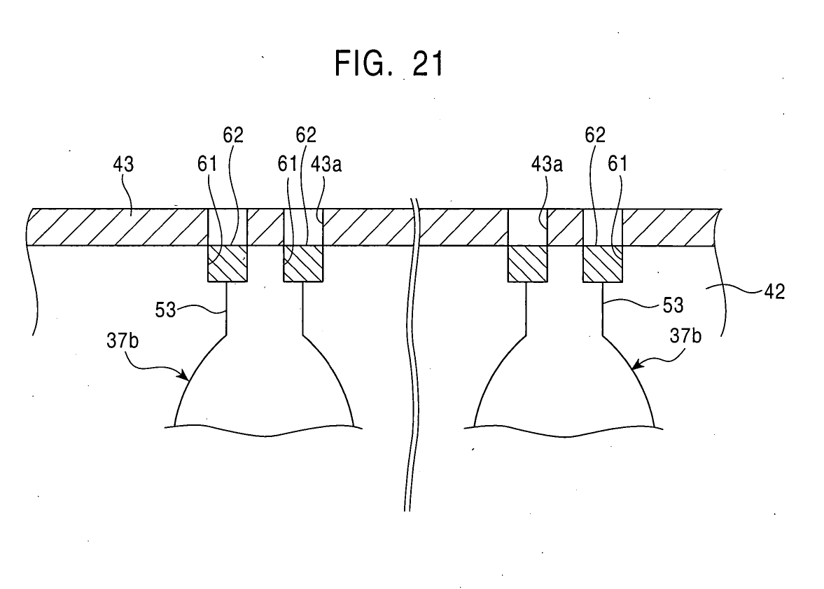

Subsequently, the trimming recesses 61 are filled with a nonmagnetic material 62, such as alumina, by, for example, evaporation, as shown in FIG. 21.

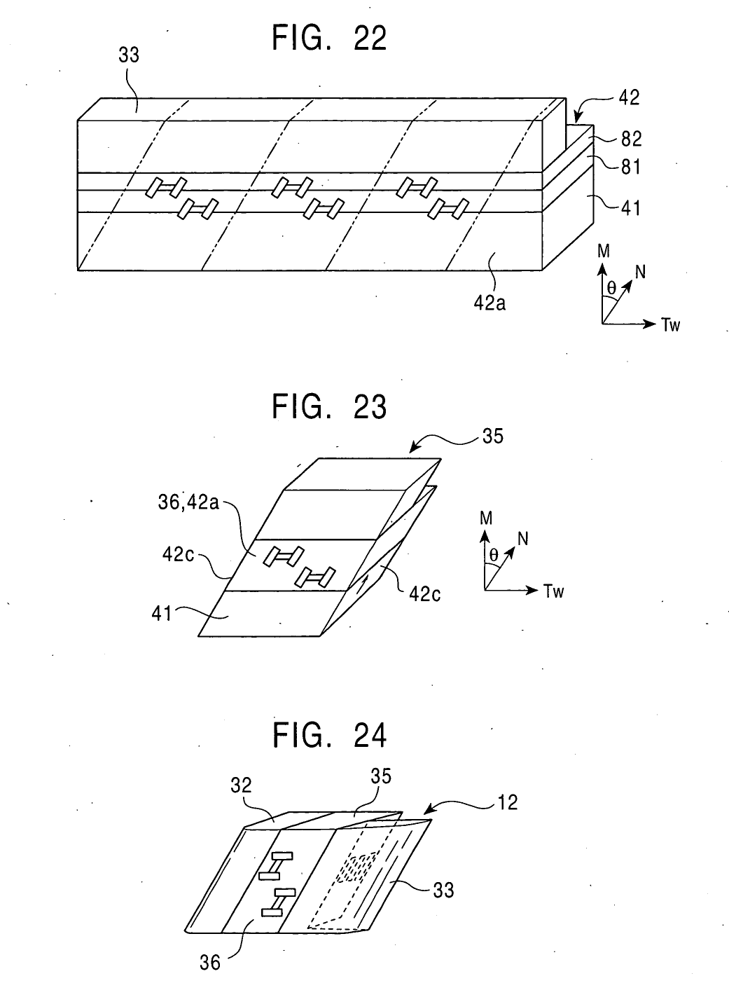

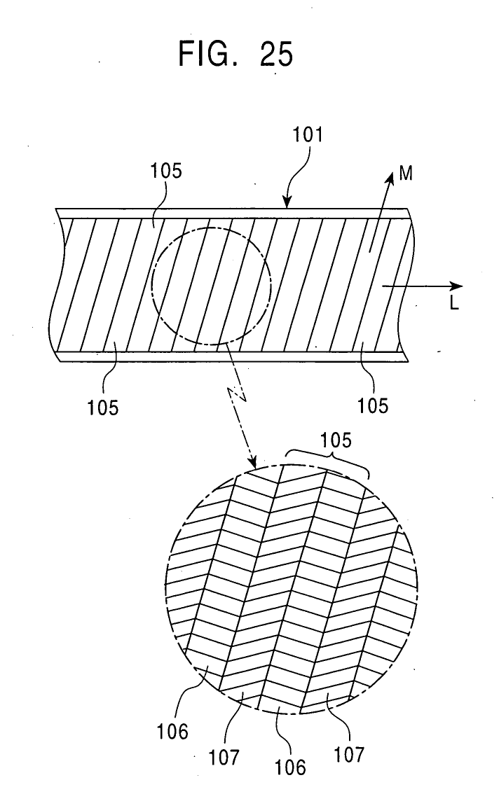

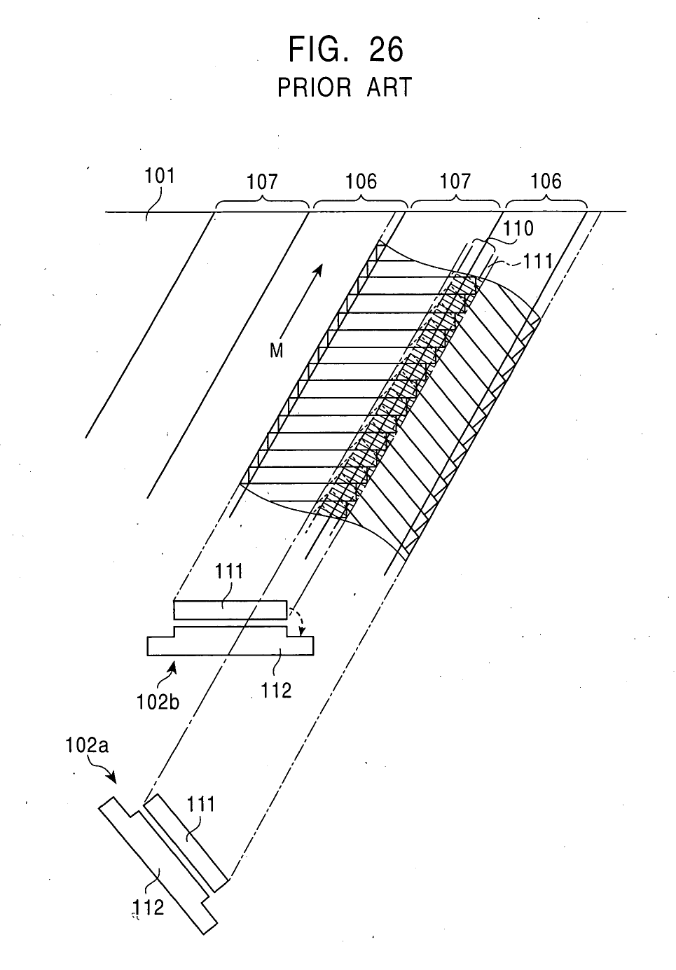

The resist film 43 is removed from the split bar 42, and the split bar 42 is then cut along two-dot chain lines shown in FIG. 22 to obtain precursory heads 212, as shown in FIG. 23. The split bar 42 is cut so that an angle θ is defined between the direction M orthogonal to the track-width direction Tw and the in-plane direction N of the cutting surface, as shown by the two-dot chain lines in FIG. 22 and FIG. 23.

Each of the precursory heads 212 is lapped with a tape to curve a medium-sliding surface 36. Finally, a magnetic head assembly 12 having two thin-film magnetic heads is obtained, as shown in FIG. 24.

In the above-described production method, since the gap layer 54 and the leading end portions 46b and 53a of the core layers 46 and 53 in the split bar 42 are trimmed by photolithography, trimming can be performed efficiently.

Even when the relative positions of the thin-film magnetic heads 37a and 37b are changed by a polishing error during the thin-film magnetic-head forming process, since the core layers 46 and 53 and the gap layer 54 are trimmed to adjust the track width Tw after the thin-film magnetic heads 37a and 37b are formed, the error in the thin-film magnetic-head forming process can be removed, and the formation of the edge lines 37c on both sides in the track-width direction of the gap layer 54 and the core layers 46 and 53 and the adjustment of the track width Tw can be performed precisely. Moreover, the inclination angle of the edge lines 37c can be fixed, and the azimuth angles of the thin-film magnetic heads 37a and 37b can be made the same.

Since the trimming recesses 61 are filled with the nonmagnetic material 62, a leakage field toward both sides in the track-width direction of the thin-film magnetic heads 37a and 37b can be reduced, and the medium-sliding surface 36 can be smoothened.

Since the thin-film magnetic heads 37b are formed after the thin-film magnetic heads 37a are covered with the overcoat layer 81, the gap layers 54 of the thin-film magnetic heads 37a and 37b can be made parallel to each other, and the azimuth angles can be made the same.

In the thin-film magnetic-head forming process, the track width of the thin-film magnetic heads 37a and 37b are set beforehand to be larger than the track width after trimming. Therefore, the track width of the thin-film magnetic heads 37a and 37b can be adjusted to a fixed width during the trimming process.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. A magnetic head assembly comprising a head container, wherein the head container comprises:
a medium-sliding surface;
a plurality of thin-film magnetic heads provided inside the head container so that widths thereof in a track-width direction are inclined at the same azimuth angle, each of the thin-film magnetic heads including a gap layer and a pair of core layers sandwiching the gap layer, and leading end portions of the gap layer and the core layers being exposed from the medium-sliding surface; and
a pair of trimming recesses provided on the medium-sliding surface,
wherein the trimming recesses include edge lines extending on both sides in the track-width direction of the gap layer and the core layers and in a traveling direction of the thin-film magnetic head.

2. The magnetic head assembly according to claim 1, wherein the trimming recesses are filled with a nonmagnetic material.

3. The magnetic head assembly according to claim 1, wherein the edge lines of the thin-film magnetic heads are parallel to one another.

4. The magnetic head assembly according to claim 1, wherein each of the core layers includes the leading end portion exposed from the medium-sliding surface, and a main core portion disposed at a distance from the medium-siding surface, and a width of the leading end portion in the track-width direction is smaller than a width of the main core portion.

5. A magnetic-tape recording and playback apparatus comprising a rotating drum having a magnetic head assembly,
wherein a tape-loading path is defined by winding a magnetic tape drawn from a tape reel on the rotating drum,
wherein the magnetic head assembly includes a head container, and the head container comprises:
a medium-sliding surface;
a plurality of thin-film magnetic heads provided inside the head container so that widths thereof in a track-width direction are inclined at the same azimuth angle, each of the thin-film magnetic heads including a gap layer and a pair of core layers sandwiching the gap layer, and leading end portions of the gap layer and the core layers being exposed from the medium-sliding surface; and
a pair of trimming recesses provided on the medium-sliding surface,
wherein the trimming recesses include edge lines extending on both sides in the track-width direction of the gap layer and the core layers and in a traveling direction of the thin-film magnetic head.

6. The magnetic-tape recording and playback apparatus according to claim 5, wherein the tape-loading path includes the rotating drum, guide posts disposed on upstream and downstream sides of the rotating drum to guide the magnetic tape drawn from the tape reel onto the rotating drum, and a capstan disposed on the downstream side of the rotating drum to feed the magnetic tape.

7. A method for producing a magnetic head assembly, comprising:
a thin-film magnetic-head forming step of forming a plurality of thin-film magnetic heads on a nonmagnetic substrate, each of the thin-film magnetic heads including a gap layer and a pair of core layers sandwiching the gap layer;
a cutting step of forming split bars by cutting the nonmagnetic substrate, each of the split bars including some of the thin-film magnetic heads, and leading end portions of the gap layer and the core layers in each of the thin-film magnetic heads being exposed from a cutting surface; and
a trimming step of forming a resist film on the cutting surface of the split bar, forming a plurality of patterning holes in the resist film, and etching the cutting surface through the patterning holes of the resist film to form a pair of trimming recesses including edge lines extending on both sides in a track-width direction of the gap layer and the core layers in the thin-film magnetic head and in a traveling direction of the thin-film magnetic head.

8. The method according to claim 7, further comprising:
a step of filling the trimming recesses with a nonmagnetic material after the trimming step.

9. The method according to claim 7, wherein, in the thin-film magnetic-head forming step, the thin-film magnetic heads comprise first thin-film magnetic heads and second thin-film magnetic heads, the first thin-film magnetic heads are formed at regular intervals on the nonmagnetic substrate, and are covered with an overcoat layer, and the second thin-film magnetic heads are formed at regular intervals on the overcoat layer so as to be offset in the track-width direction from the first thin-film magnetic heads.

10. The method according to claim 7, wherein, in the thin-film magnetic-head forming step, a width of the thin-film magnetic heads in the track-width direction is set to be larger than a track width required after the trimming step.
